(19) United States
(12) Patent Application Publication
(10) Pub. No.: US 2024/0411836 A1
(43) Pub. Date: Dec. 12, 2024

(54) METHOD AND SYSTEM FOR DETECTING FLIGHT REGIMES OF AN AIRCRAFT, ON THE BASIS OF MEASUREMENTS ACQUIRED DURING AN AIRCRAFT FLIGHT

(71) Applicant: LEONARDO S.P.A., ROMA (IT)

(72) Inventors: Andrea Baldi, Samarate (VA) (IT); Ugo Mariani, Samarate (VA) (IT); Daniele Mezzanzanica, Samarate (VA) (IT); Mara Tanelli, Milano (MI) (IT); Jessica Leoni, Milano (MI) (IT); Francesco Zinnari, Berlin (DE); Eugenia Villa, Milano (MI) (IT)

(73) Assignee: LEONARDO S.P.A., ROMA (IT)

(21) Appl. No.: 18/698,408

(22) PCT Filed: Oct. 11, 2022
(86) PCT No.: PCT/IB2022/059718

§ 371 Date: Apr. 4, 2024

(30) Foreign Application Priority Data
Oct. 11, 2021 (EP) 21425046.6

(51) Int. Cl. G06F 17/17; B64D 45/00; G06F 17/16

(52) U.S. Cl. CPC G06F 17/17; G06F 17/16; B64D 2045/0085

(57) ABSTRACT

Method implemented by computer for detecting flight regimes of an aircraft equipped with a monitoring system that acquires samples of quantities relative to the flight including: acquiring an unknown matrix including, for each quantity, a corresponding series of samples; performing smoothing operations of each series of samples, so as to generate a corresponding series of smoothed samples and determining a corresponding approximating function defined by a respective series of coefficients and by a plurality of base functions, the smoothed series of samples forming a smoothed unknown matrix; on the basis of the base functions, applying to the smoothed unknown matrix and to the corresponding sets of coefficients a classifier trained to generate, for each flight regime among a plurality of flight regimes, a corresponding estimate of the probability that the smoothed unknown matrix and the corresponding sets of coefficients belong to a cluster relative to the flight regime; identifying a flight regime in which the aircraft operated, on the basis of the estimates generated by the classifier.

### CROSS-REFERENCE TO RELATED APPLICATIONS

This Patent application claims priority from European Patent Application No. 21425046.6 filed on Oct. 11, 2021, the entire disclosure of which is incorporated herein by reference.

### TECHNICAL FIELD

The present invention relates to a method and system for detecting flight regimes of an aircraft, on the basis of measurements acquired during an aircraft flight.

### BACKGROUND

As is known, in aeronautics the need to monitor the state of fatigue, and more generally the state of health, of the components of an aircraft, for example in order to estimate with precision the residual life time of each component, and therefore optimise maintenance activities, without compromising flight safety, is particularly felt.

In particular, it is known that the state of fatigue to which the components of an aircraft are subjected depends on the manoeuvres to which, during usage, the aircraft has been subjected, since the loads to which each component is subjected depend on the manoeuvres carried out by the aircraft. Consequently, the need is felt to correctly detect the manoeuvres performed by an aircraft, in order to then be able to determine the so-called real usage spectrum. To this end, it is known to equip aircraft with monitoring systems adapted to detect the values of quantities relative to the flight; this makes it possible to acquire a large number of measurements of these quantities, which can be analysed to reconstruct the history of the manoeuvres carried out by the aircraft.

For example, FIG. 1A shows a helicopter 1, which is equipped with a monitoring system 2, which includes sensors adapted to measure corresponding quantities, which are referred to in the following as primary quantities. Generally, the samples of the primary quantities are generated with a certain sampling frequency, typically in the order of about ten Hertz. Purely by way of example, the primary quantities may include: variables related to the aircraft kinematics (e.g. pitch angle, roll angle, yaw angle, vertical acceleration, vertical speed, longitudinal acceleration, lateral acceleration, roll rate, pitch rate, yaw rate, northbound speed, eastbound speed, main rotor speed); variables related to the aircraft controls (such as, for example, collective control position, lateral position cyclic control, longitudinal position cyclic control, pedal position); environmental variables (such as, for example, air speed, radar altitude, barometric altitude, wind speed, wind direction, total air temperature); variables related to the energy systems (such as, for example, the torque of the motors, the rotation speed of the engine turbines, the rotation speed of the engine generators).

For example, FIG. 1B shows the trends over time of five primary quantities (denoted respectively as quantities 1-5), which are monitored by corresponding sensors of the monitoring system 2, which periodically provide the corresponding samples.

That being said, the Applicant has observed that, even having such measurements, the correct detection of the executed manoeuvres requires an analysis by means of advanced data processing techniques and is further hampered by the fact that different manoeuvres typically have different durations, which the analysis complicates of the aforementioned temporal trends.

In order to overcome the problem of the different manoeuvre durations, European patent application No. 20425059.1, filed on 18 Dec. 2020 on behalf of the Applicant, describes a method implemented by computer for detecting the execution, by an aircraft, of a manoeuvre belonging to a macrocategory among a plurality of predetermined macrocategories. In particular, as shown in FIG. 2, the set (denoted by 5) of the manoeuvres that may be carried out by an aircraft can be subdivided into a plurality of subsets, to which in the continuation reference is indeed made as to the macrocategories (denoted by MC). Each macrocategory MC groups together subclasses of manoeuvres with similar features. For example, FIG. 2 shows macrocategories MC related to level flight, bank turn, vertical take-off, climb, etc., respectively. In turn, the macrocategory related to level flight may include a plurality of manoeuvres (only four shown in FIG. 2, indicated by “forty-node level flight”, “sixty-node level flight”, “ninety-node level flight” and “one hundred and fifty-node level flight”). In other words, each macrocategory MC represents a corresponding class of manoeuvres, i.e. a corresponding flight regime.

That being said, the method described in the European Patent Application No. 20425059.1 envisages acquiring a data structure including a plurality of temporal series of values of quantities relative to a flight of the aircraft, and subsequently performing, for each instant of time of a succession of instants of time, the steps of: for each temporal duration among a plurality of predetermined temporal durations, selecting a corresponding subset of the data structure having a temporal extent equal to the temporal duration and centred as a function of the instant of time; from each selected subset of the data structure, extracting a corresponding feature vector; on the basis of the feature vectors, generating a corresponding input macrovector, alternatively by aggregation of the feature vectors or by performing classifications of the feature vectors, in order to generate input prediction vectors (each of which is indicative, for each macrocategory, of a corresponding probability that, in said instant of time of the succession of instants of time, the aircraft was performing a manoeuvre belonging to said macrocategory) and subsequent aggregation of the input prediction vectors. The method further envisages to perform, for each instant of time of the succession of instants of time, the steps of: applying to the input macrovector an output classifier, which is configured to generate a corresponding output vector including, for each macrocategory, a corresponding estimate of the probability that, in the aforementioned instant of time of the succession of instants of time, the aircraft was performing a manoeuvre belonging to this macrocategory; on the basis of the output vector, detecting the macrocategory to which the manoeuvre performed by the aircraft in the aforementioned instant of time of the succession of instants of time belongs.

In more detail, the method described in the aforementioned European patent application No. 20425059.1 requires a training a plurality of classifiers in a supervised manner. Such training requires having a training data structure that stores the temporal series (understood as successions of samples associated with corresponding temporal instants) formed by the values of the primary quantities detected by the helicopter monitoring systems during test flights; furthermore, it is necessary for pilots to label the test manoeuvres performed during test flights, so that the training data structure stores, for each test manoeuvre, the macrocategory to which the test manoeuvre belongs. In this way, the training data structure is formed by a plurality of portions, referred to as data groups, each of which is associated with a corresponding macrocategory; furthermore, these portions may possibly be interspersed with portions referring to unlabelled periods of time, i.e. periods of time in which the pilots did not report performing manoeuvres. For example, FIG. 1B show a first and a second time interval T1, T2, wherein respectively a first and a second test manoeuvre M1, M2 of a test flight of the helicopter 1 are verified, which are reported by the pilot, belong to corresponding macrocategories (possibly, to a same macrocategory) and correspond to the data groups denoted respectively with DG1 and DG2; furthermore, in FIG. 1B three periods of time are denoted by NMP1, NMP2, NMP3 respectively, which are spaced with respect to the first and second time interval T1, T2, wherein no manoeuvres are reported by the pilot; in other words, the periods of time NMP1, NMP2, NMP3 are unlabelled periods.

The training of the classifiers is thus carried out, in a supervised manner, on the basis of the training data structure and is a function of the macrocategories reported by the pilots during test flights (also known as load survey flights).

The method described in the aforementioned European Application No. 204250591 therefore allows the Patent macrocategories to which the manoeuvres performed by an aircraft belong to be detected with high precision, however it is based on the aforementioned feature extraction; consequently, the method is not very dependent on the actual waveforms of the primary quantities, which, in some situations, can lead to a reduction in the accuracy of the detection.

The document “Airborne sensor data-based unsupervised recursive identification for UAV flight phases”, IEEE SENSORS JOURNAL, vol. 20, no.18, Sep. 15, 2020, of Benkuan Wang et al. discloses a Gaussian Mixture Model (GMM) clustering to identify flight phases. Furthermore, in order to reduce the identification errors caused by the fluctuations of the flight data, the flight data are pre-processed to achieve data smoothing.

The document “Unsupervised flight phase recognition with flight data clustering based on GMM”, 2020 IEEE International Instrumentation and Measurement Technology Conference, 25 May 2020, pages 1-6, of Datong Liu et al. discloses a flight phase recognition method based on Gaussian Mixture Model (GMM). Furthermore, in order to solve the problem of different parameter lengths, the cubic spline interpolation is used.

CN 112 257 152A discloses a method for identifying flight phases based on aircraft data, which leverages a threshold-based approach and provides for a density-based spatial clustering of applications with noise (DBSCAN) to fix misclassifications.

US 2011/0288836 discloses detecting anomalies in an aero-engine; the anomaly detection is achieved by comparing the estimated singularities (zeros and poles) of a transfer function (in the Laplace domain) of the considered regime instance and of a reference function.

### SUMMARY

Aim of the present invention is to provide a method for detecting flight regimes, which overcomes at least in part the drawbacks of the prior art.

According to the present invention, there are provided a method and a system for detecting flight regimes, as defined in the appended Claims.

### BRIEF DESCRIPTION OF THE DRAWINGS

To better understand the present invention preferred embodiments thereof will be now described, for merely exemplary and non-limiting purposes, with reference to the appended drawings, wherein:

FIG. 1A schematically shows a view of an aircraft equipped with a monitoring system;

FIG. 1B shows examples of trends over time of values of quantities acquired through monitoring systems;

FIG. 2 shows a block diagram which exemplifies a possible subdivision into macrocategories of a set of manoeuvres that can be executed by an aircraft;

FIGS. 3 and 11 show block diagrams relative to operations according to the present method;

FIGS. 4, 6, 10 and 12 show block diagrams of data structures acquired according to the present method;

FIG. 5 shows a Cartesian graph on which a plurality of samples and an approximating function are arranged;

FIG. 7 shows examples of temporal trends of a plurality of functions;

FIG. 8 shows trends over time of signals, before and after the execution of registration operations; and

FIG. 9 shows examples of temporal trends of a plurality of functions deriving from the execution of registration operations of the functions shown in FIG. 7.

### DESCRIPTION OF EMBODIMENTS

Purely by way of example, the present method is now described with reference to the helicopter 1; moreover, it is assumed that the monitoring system 2 allows to monitor a number NQ of primary quantities; purely by way of example, it is assumed NQ=5, unless otherwise specified. Furthermore, it is assumed that the number of possible flight regimes to be detected is equal to NUM_REG (for example, NUM_REG=19).

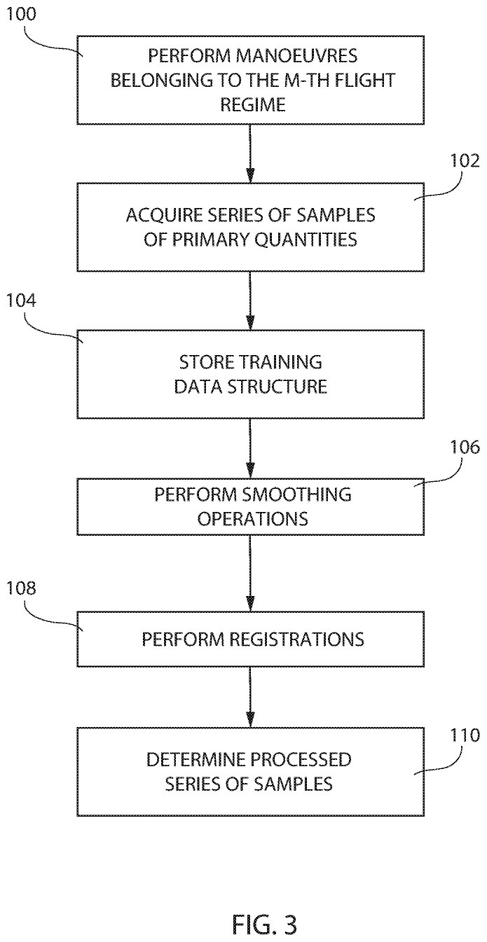

That being said, for each of the aforementioned flight regimes, the operations shown in FIG. 3 are performed, which refer, by way of example, to a generic m-th flight regime.

In detail, the helicopter 1 performs (block 100) a number equal to Ninst (for example, Ninst=39) of manoeuvres belonging to the m-th flight regime; during the execution of each of these manoeuvres, the monitoring system 2 acquires (block 102), for each primary quantity, a corresponding series of samples, which includes a number of samples Nsmax (for example, Nsmax=350). Without any loss of generality, for the sake of simplicity it is assumed that the temporal series of samples are acquired at the same sampling rate and aligned over time, i.e. in a manner that, at each sampling time, corresponding samples of all primary quantities are acquired.

For example, referring to the i-th primary quantity (with i varying between 1 and NO) and to the j-th manoeuvre (with j varying between 1 and Ninst), the monitoring system 2 acquires a corresponding series of samples sᵢⱼ [n], with n integer ranging between 1 and Nsmax.

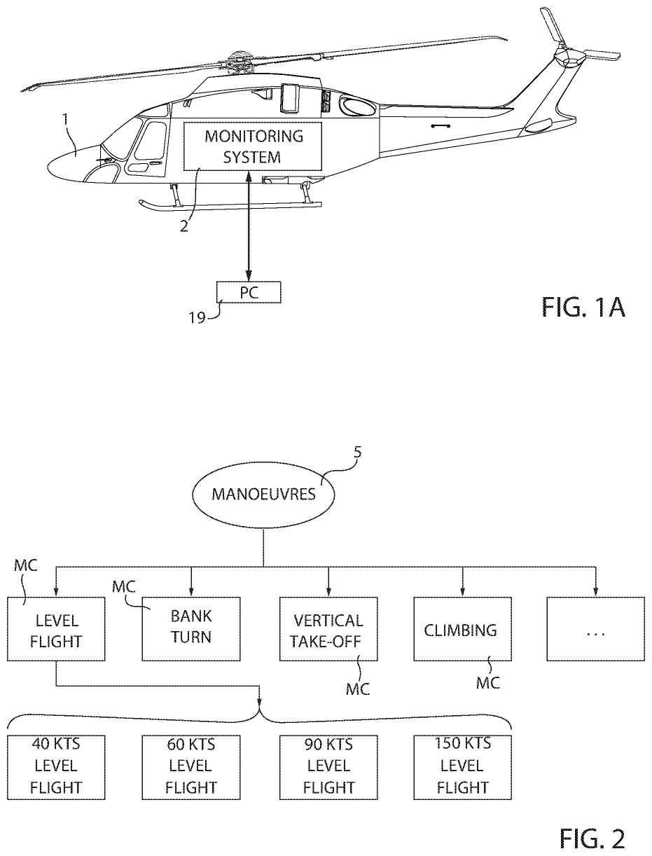

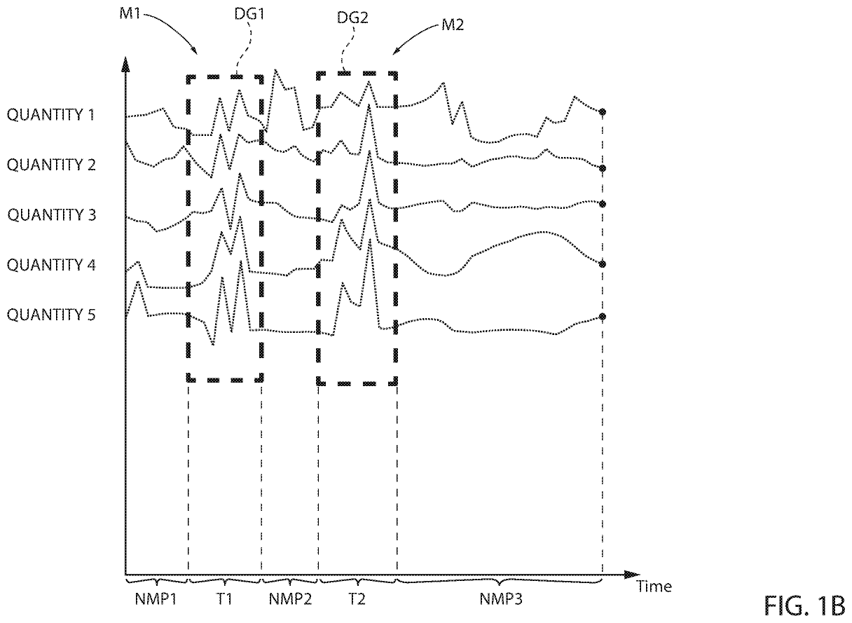

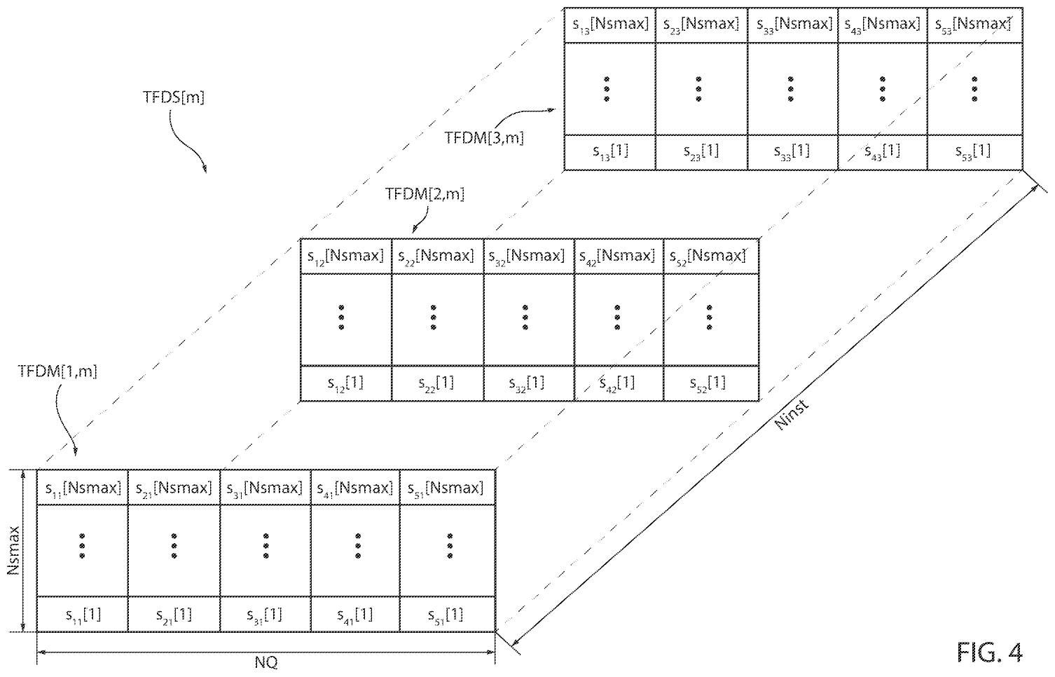

In practice, each manoeuvre belonging to the m-th flight regime represents an instance of the m-th flight regime, which is associated to a corresponding training data matrix TFDM [j, m], whose columns are formed by the series of samples sᵢⱼ [n]-s_{Noj} [n]. Consequently, the execution of the Ninst manoeuvres belonging to the m-th flight regime allows to store (block 104, FIG. 3) a corresponding training data structure TFDS [m], shown qualitatively in FIG. 4, wherein for simplicity's sake of visualisation Ninst=3 has been assumed (in addition to, as previously mentioned, NQ=5). In the following it is assumed, for simplicity's sake, that the training data structures TFDS [m] are stored in a computer 19 (shown in FIG. 1A), which can be coupled to the monitoring system 2.

Subsequently, for each of the aforementioned flight regimes, for each series of samples sᵢⱼ [n] of each training data matrix TFDM [j,m] of the corresponding training data structure TFDS [m], a so-called smoothing operation (block 106, FIG. 3) is performed, as described below; purely by way of example, it is assumed that the smoothing operation is carried out by the computer 19.

In detail, considering each series of samples sᵢⱼ [n] of the training data structure TFDS [m] relative to the m-th flight regime, the computer 19 determines, in a per se known manner, a corresponding approximating function Fᵢⱼ (t) of time-continuous type.

In more detail, the approximating function Fᵢⱼ (t) can be defined as a linear combination of a series of base functions (also known briefly as bases), which define a corresponding Hilbert space; the approximating function Fᵢⱼ (t) thus corresponds to a point in Hilbert space. Furthermore, the approximating function Fᵢⱼ (t) is not bound to pass through the samples of the respective series sᵢⱼ [n] and has a smoother trend than the samples of the respective series sᵢⱼ [n].

Even in more detail, assuming that a number K of base functions φₖ (t) is adopted, the smoothing operation allows to determine a corresponding set of coefficients Ck_{k,ij} so that it results in:

$${F}_{i j} ( t ) = {\sum }_{k = 1}^{K} {C}_{k , i j} * {φ}_{k} ( t )$$

Purely by way of example, the base functions ok (t) may be formed by Fourier bases (i.e., sine or cosine functions) or by polynomials or splines; in such cases, a so-called basis smoother is implemented. Alternatively, the base functions ok (t) may be formed by so-called kernels, i.e., by non-linear functions, in which case a so-called “kernel smoother” is implemented.

Without any loss of generality, in the present description it is assumed that, for each series of samples sᵢⱼ [n] of the training data structure TFDS [m], the computer 19 performs a so-called “kernel nearest neighbour smoothing”, i.e., kernels are adopted that perform non-linear operations on corresponding subsets of adjacent samples of each series of samples sᵢⱼ [n]. Consequently, in each point of the approximating function Fᵢⱼ (t), it occurs that the corresponding value of the approximating function Fᵢⱼ (t) depends on the samples of the series sᵢⱼ [n] surrounding this point.

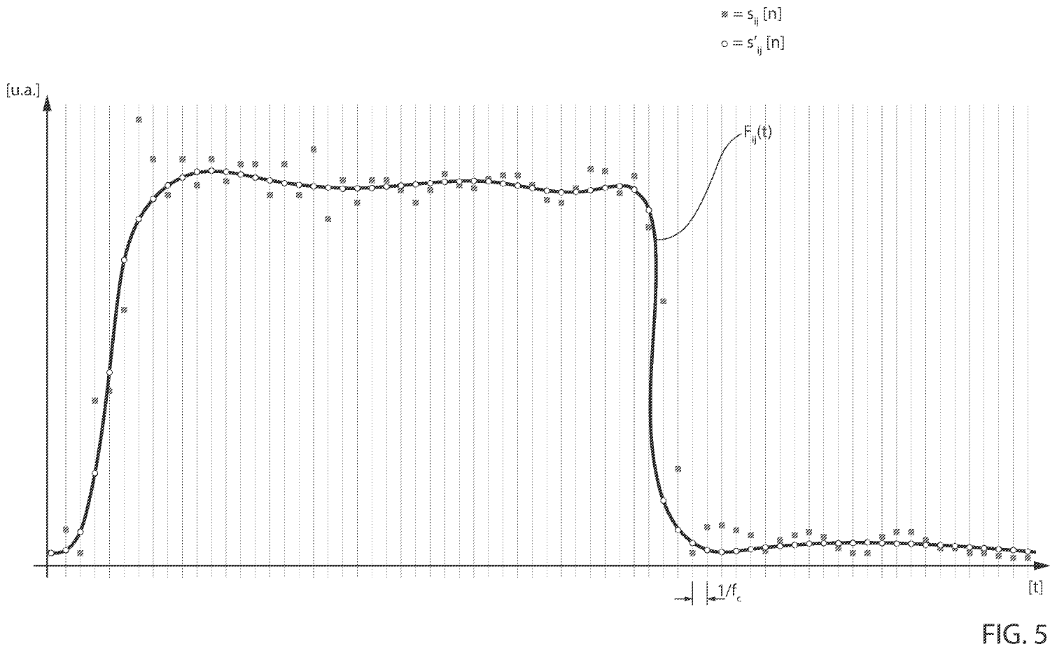

An example of the relationship present between a generic series of samples sᵢⱼ [n] and the corresponding approximating function Fᵢⱼ (t) is shown in FIG. 5, wherein the samples of the series sᵢⱼ [n] follow one another temporally at a rate equal to the aforementioned sampling rate (denoted by fc).

In practice, since the computer 19 has determined, for each series of samples sᵢⱼ [n] of the training data structure TFDS [m] relative to the m-th flight regime, the corresponding set of coefficients C_{k,ij}, the computer 19 is able to determine the value assumed by the corresponding approximating function Fᵢⱼ (t) at any temporal instant. In other words, the computer 19 has performed a functional analysis, i.e. it has reconstructed, from the available samples, the mathematical function of the process underlying these samples.

Furthermore, the smoothing operation includes calculating, for each sample of the series sᵢⱼ [n], a corresponding sample of a series s′ᵢⱼ [n], which is referred to in the following as the smoothed series s′ᵢⱼ [n].

In detail, for each sample of the series sᵢⱼ [n], the corresponding sample of the smoothed series s′ᵢⱼ [n] is equal to the corresponding value of the corresponding approximating function Fᵢⱼ (t), as shown for example in FIG. 5. In other words, referring to the case wherein n=n0, and thus referring to the sample sᵢⱼ [n0] of the series of samples sᵢⱼ [n], the corresponding sample s′ᵢⱼ [n0] of the smoothed series s′ᵢⱼ [n] is equal to the value of the approximating function Fᵢⱼ (t) relative to n0*1/fc.

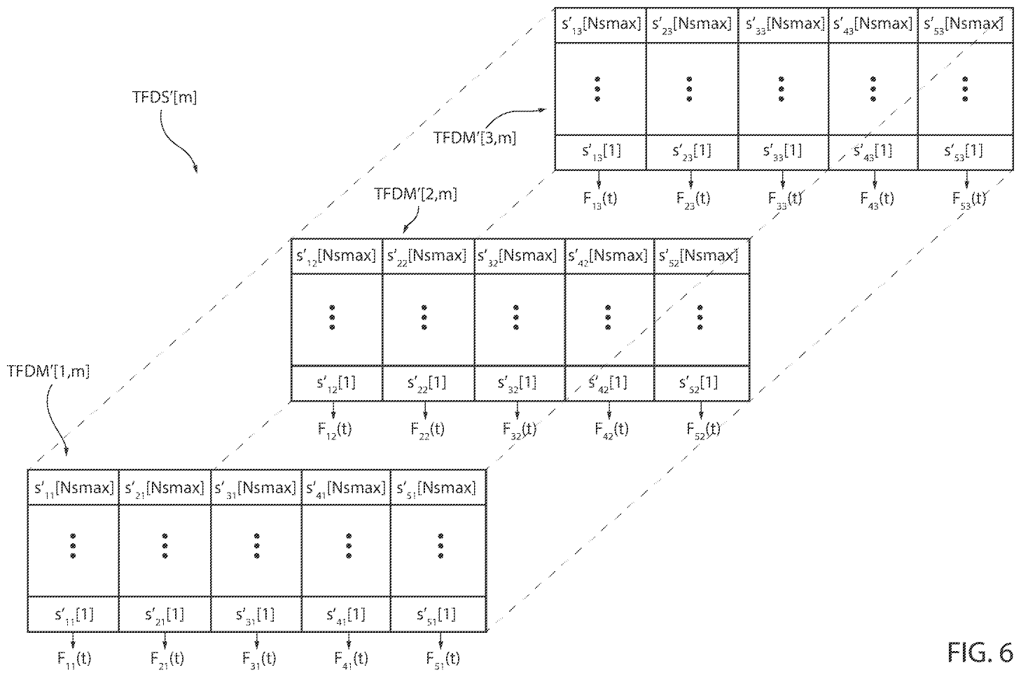

At the end of the operations referred to in block 106, the computer 19 has therefore, for each primary quantity (therefore, for each value of the index i), a corresponding plurality of smoothed series s′ᵢⱼ [n], as well as a corresponding plurality of sets of coefficients C_{k,ij}, which define the approximating functions Fᵢⱼ (t) relative to the aforementioned smoothed series s′ᵢⱼ [n]. Consequently, the computer 19 stores, for each manoeuvre belonging to the m-th flight regime, a corresponding smoothed training data matrix TFDM′ [j, m], whose columns are formed by the smoothed series s′ᵢⱼ [n]-s′N_{Qj} [n]; moreover, relative to the m-th flight regime, the computer 19 stores a corresponding smoothed training data structure TFDS' [m], which is formed by a number equal to Ninst of smoothed training data matrices TFDM′ [j, m], as shown qualitatively in FIG. 6, in which the associations present between each smoothed series s′ᵢⱼ [n] and the corresponding approximating function Fᵢⱼ (t) (and therefore the corresponding set of coefficients C_{k,ij}) are also shown.

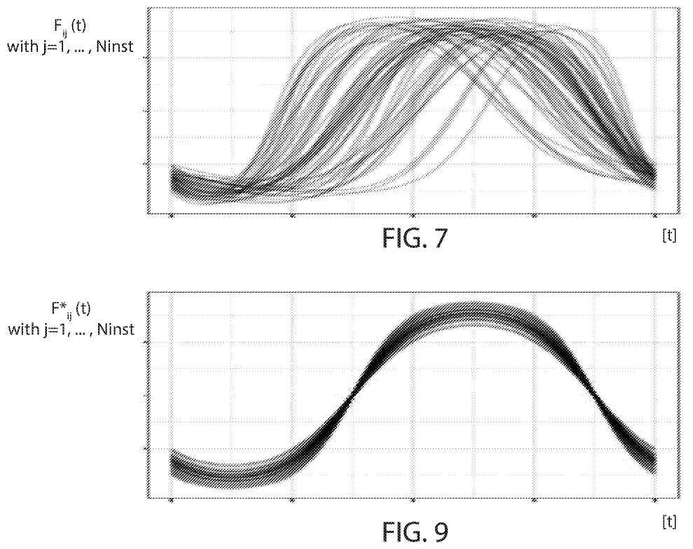

For example, FIG. 7 shows examples (in number equal to Ninst) of trends of the approximating functions Fᵢⱼ (t) (with fixed i and with j=1, . . . , Ninst) relating to the i-th primary quantity and to the execution of manoeuvres belonging to the m-th regime.

Then, for each primary quantity, the computer 19 performs (block 108) a so-called shift-registration operation of the approximating functions Fᵢⱼ (t) relative to the primary quantity.

In particular, considering a generic i-th primary quantity, the computer 19 processes in a per se known manner the corresponding approximating functions Fᵢⱼ (t) (with fixed i and j=1, . . . , Ninst), so as to generate a corresponding set formed by a number equal to Ninst of shifted approximating functions F*ᵢⱼ (t), which have profiles that are more aligned with each other than the profiles of the approximating functions Fᵢⱼ (t) from which they derive.

In more detail, for each primary quantity, it is verified that, starting from each approximating function Fᵢⱼ (t), a corresponding shifted approximating function F*ᵢⱼ (t) is generated, which is in fact shifted over time with respect to the corresponding approximating function Fᵢⱼ (t), so that the shifted approximating functions F*ᵢⱼ (t) have forms (trends over time) that are overall more superimposable between them than what happens in the case of the approximating functions Fᵢⱼ (t).

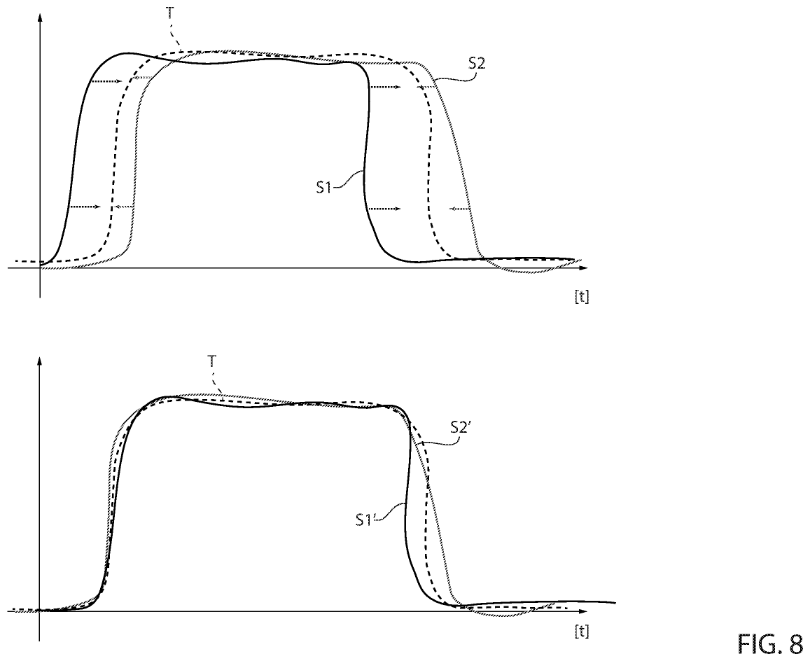

In general, and in a per se known manner, the registration may be of the so-called landmark-based type, therefore based on the possibility of having a reference curve (known as a “template”) of which the temporal instants at which so-called fiducial points occur are known a priori; in this case, the registration aims at aligning the fiducial points of the functions to the fiducial points of the curve of reference. Alternatively, and still by way of example, the registration may be of the so-called continuous (or simple) type, in which case no information on the form of the functions to be registered is known a priori; consequently, points common to the approximating functions Fᵢⱼ (t) are initially sought, on the basis of which the shifts are then performed. Purely by way of example, FIG. 8 shows examples of two signals, denoted by S1 and S2 respectively, which undergo a registration operation of the type based on points of reference, and in particular on the basis of a template denoted by T, with the consequent generation of corresponding shifted signals denoted by S1′ and S2′, which are respectively delayed with respect to the signal S1 by a time 41 and in advance with respect to the signal S2 by a time 42.

By way of example, in the present case it is assumed that the registration, in addition to being of the shift type, is of the so-called continuous type, i.e. without resorting to templates.

FIG. 9 shows examples of shifted approximating functions F*ᵢⱼ (t) that can be obtained by performing shift registration operations of the approximating functions Fᵢⱼ (t) shown in FIG. 7.

The registration operations thus make it possible to thus determine, for each approximating function Fᵢⱼ (t), the phase shift (this is a time, hereafter denoted by Δᵢⱼ) between the approximating function Fᵢⱼ (t) and the corresponding shifted approximating function F*ᵢⱼ(t), which are defined by the same set of coefficients C_{k,ij}, as well as by the same base functions, since they differ from each other only in a shift over time.

Then, the computer 19 determines (block 110, FIG. 3), for each smoothed series s′ᵢⱼ [n] of the smoothed training data structure TFDS' [m] relative to the m-th flight regime, a corresponding processed series of samples s″ᵢⱼ [n], based on the corresponding phase shift Δᵢⱼ; in particular, the processed series of samples s″ᵢⱼ [n] is obtained by shifting over time the smoothed series s′ᵢⱼ [n] of the same phase shift Δᵢⱼ present between the corresponding approximating function Fᵢⱼ (t) and the corresponding shifted approximating function F*ᵢⱼ (t). The processed series of samples s″ᵢⱼ [n] is in any case formed by a number of samples equal to Nsmax; moreover, the shift over time may imply that some of the samples of the smoothed series s′ᵢⱼ [n] are removed (because they are shifted outside the considered temporal interval) and may imply “zero padding” operations of the processed series of samples s″ᵢⱼ [n], in order to guarantee that its number of samples is in any case equal to Nsmax.

Each processed series of samples s″ᵢⱼ [n] is associated with the same set of coefficients C_{k,ij} to which the corresponding smoothed series s′ᵢⱼ [n] is associated, and thus also the corresponding series of sample sᵢⱼ [n], these associations being stored by the computer 19.

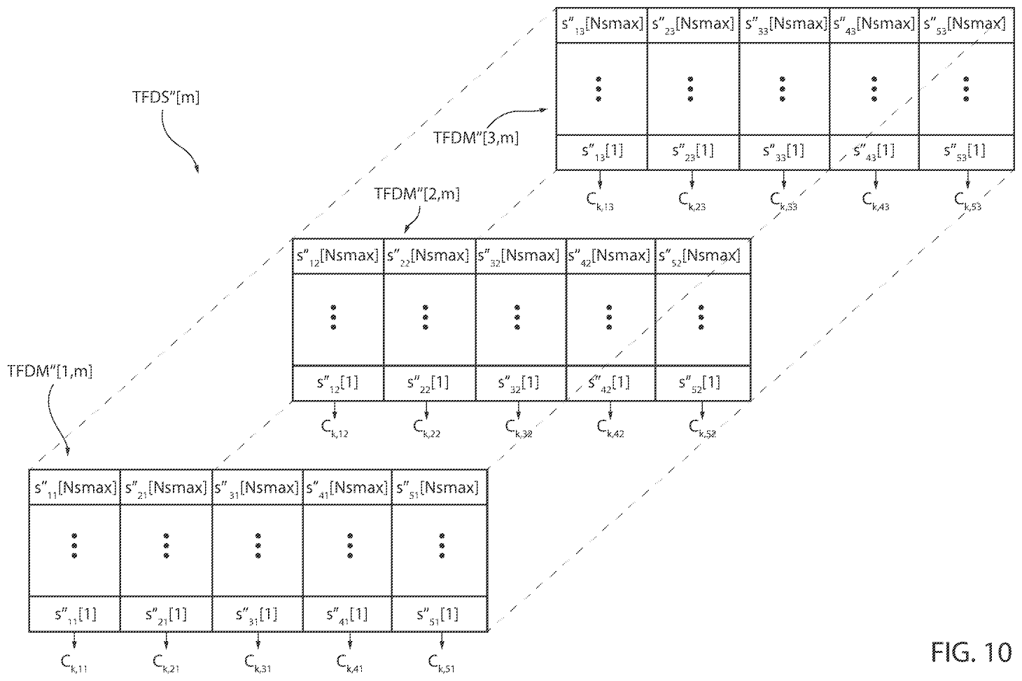

The operations referred to in blocks 106-110 allow to determine, for each series of samples sᵢⱼ [n] of the training data structure TFDS [m] relative to the m-th flight regime, a corresponding processed series of samples s″ᵢⱼ [n]. Consequently, the computer 19 stores, for each training data matrix TFDM [j,m], a corresponding processed training data matrix TFDM″[j,m], which represents a so-called “clean” version of the corresponding training data matrix TFDM [j, m] and is associated with the aforementioned m-th flight regime, this association being stored by the computer 19. Furthermore, each processed training data matrix TFDM″[j, m] is associated with a corresponding group of sets of coefficients C_{k,ij}, which includes the sets of coefficients C_{k,ij} to which the processed series of samples s″ᵢⱼ [n] forming the processed training data matrix TFDM″[j, m] are respectively associated, these associations being stored by the computer 19 and qualitatively represented in FIG. 10.

As shown qualitatively again in FIG. 10, the processed training data matrices TFDM″[j, m] form a processed training data structure TFDS″[m], which is still associated with the m-th flight regime, this association being stored by the computer 19.

Since the operations shown in FIG. 3 are repeated, as previously mentioned, for each of the flight regimes, the computer 19 has at its disposal a number equal to Ntot=Ninst * NUM_REG processed training data matrices TFDM″[j, m], each of which is associated with a corresponding flight regime.

In general, the operation of registering the approximating functions Fᵢⱼ (t) and the subsequent generation of the processed series of samples s″ᵢⱼ [n] are in any case optional; in other words, the operations which are described below with reference to the processed series of samples s″ᵢⱼ [n] can be performed on the smoothed series s′ᵢⱼ [n]. However, the operation of registering the approximating functions Fᵢⱼ (t) and the subsequent generation of the processed series of samples s″ᵢⱼ [n] allow to emphasise the differences between the forms of the approximating functions Fᵢⱼ (t), and thus between the smoothed series s′ᵢⱼ [n], due to real structural changes, reducing the impact, on the detection method, of the differences due to mere temporal shifts, for example attributable to different instants of start of sample acquisition. The registration therefore allows to improve the accuracy of the detection of flight regimes.

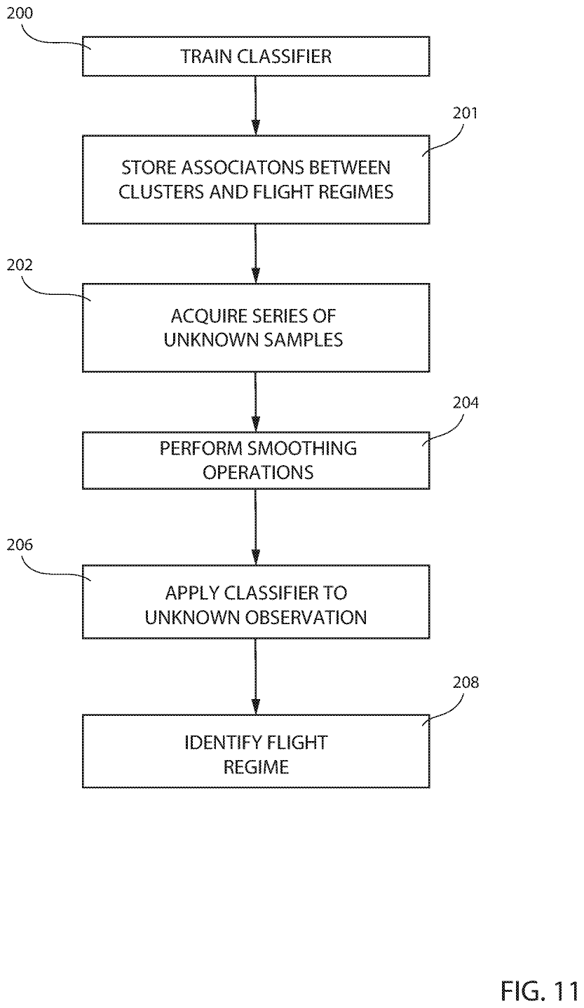

That being said, as shown qualitatively in FIG. 11, the computer 19 trains (block 200) a classifier, which in the following is assumed to be of the so-called “fuzzy C-means” type; the training is performed on the basis of the processed training data matrices TFDM″[j, m], which as said are in a number equal to Ntot, as well as on the basis of the groups of sets of coefficients C_{k,ij} associated with the processed training data matrices TFDM″[j, m]. In practice, each processed training data matrix TFDM″[j, m] represents, together with the corresponding group of sets of coefficients C_{k,ij} (which are referred to the aforementioned base functions φₖ (t)), a so-called observation.

In more detail, the training of the classifier provides, in a per se known manner, for identifying a number of clusters equal to the number NUM_REG of flight regimes, by iteratively minimising a cost function that can be expressed as:

$$F = {\sum }_{o = 1}^{Ntot} {\sum }_{c = 1}^{NUM \_ REG} {μ}_{co}^{d} {‖ {x}_{o} - {υ}_{c} ‖}_{*}^{2} with {\sum }_{c = 1}^{NUM \_ REG} {μ}_{co} = 1$$

wherein: xₒ represents the result of a so-called embedding of the o-th observation; U_{c} represents the result of the embedding of the current estimate of the c-th centroid (with c=1, . . . , NUM_REG); d represents the so-called “degree of fuzzyness”; μ_{co} represents the current membership degree of the c-th cluster of the o-th observation; the operation denoted by ∥(·)∥* represents any norm (e.g., the so-called norm L²), which is calculated on the difference between the aforementioned embedding results.

In addition, at each iteration, either the membership degrees and the centroids (equivalently, the relative embeddings) are updated in a per se known manner, respectively by means of the equations:

$${μ}_{c o} = {[ {\sum }_{p = 1}^{NUM \_ REG} {( \frac{{‖ {x}_{o} - {υ}_{c} ‖}_{*}^{2}}{{‖ {x}_{o} - {υ}_{p} ‖}_{*}^{2}} )}^{\frac{2}{d - 1}} ]}^{- 1}$$

$${v}_{c} = ( {\sum }_{o = 1}^{Ntot} {μ}_{c o}^{d} {x}_{o} ) / ( {\sum }_{o = 1}^{Ntot} {μ}_{c o}^{d} )$$

In more detail, the embedding of any observation envisages calculating a quantity (e.g., a vector one) that has a dimensionality lower than the dimensionality of the corresponding processed training data matrix TFDM″[j, m] and is a function of the corresponding processed series of samples s″ᵢⱼ [n] and of the temporal trends of the corresponding approximating functions Fᵢⱼ (t). In other words, embedding is of the time-dependent type, since it depends not only on the values of the processed series of samples s″ᵢⱼ [n], but also on the forms of the corresponding approximating functions Fᵢⱼ (t).

For example, embedding an observation relative to any processed training data matrix TFDM″[j, m] may involve calculating a vector having a number of elements equal to NQ, wherein the i-th element (with i=1, . . . , NQ) is a function of the processed series of samples s″ᵢⱼ [n] (with fixed j) and of the corresponding set of coefficients C_{k,ij} (with fixed j), so that this element depends on the form over time of the corresponding approximating function Fᵢⱼ (t).

That being said, the embedding of the centroids is performed in the same way as the embedding of observations. In this regard, it is known that each centroid is equal, for example, to the average of the observations weighted by the respective membership degrees, therefore each centroid can be associated with a corresponding matrix, which is equal to a weighted average of the processed training data matrices TFDM″[j, m] relative to the observations; on the basis of the matrix associated to the centroid, it is also possible to calculate a corresponding group of sets of coefficients, by performing “kernel nearest neighbour smoothing” operations, the such coefficients being then also referred to t aforementioned base functions φₖ (t), and thus to the aforementioned kernels.

After training the classifier, the computer 19 stores (block 201, FIG. 11) the associations present between the clusters (in a number equal to NUM_REG) and the corresponding flight regimes. In detail, each cluster is associated with the flight regime that is the most represented within the cluster, in the hypothesis that each observation is assigned to the cluster with respect to which it has the highest membership degree; in other words, referring to a generic cluster and assuming that, among the observations assigned to this cluster, most of them are related to a given flight regime among the possible flight regimes (the latter being in a number equal to NUM_REG), the computer 19 stores the association between this cluster and the given flight regime. In this regard, ideally each cluster includes observations related only to the corresponding flight regime.

Subsequently, the computer 19 is able to detect unknown flight regimes, as described below.

In detail, the helicopter 1 performs an unknown flight, i.e. a flight in which the performed manoeuvres are not known. The unknown flight is formed by a succession of unknown flight segments so that, for each unknown flight segment, the monitoring system 2 acquires (block 202, FIG. 11), for each primary quantity, a corresponding series of samples formed by a number of samples still equal to Nsmax. For example, referring to the i-th primary quantity (with i varying between 1 and NQ), the monitoring system 2 acquires a corresponding series of samples sxᵢ [n], which is referred to below as the series of unknown samples sxᵢ [n].

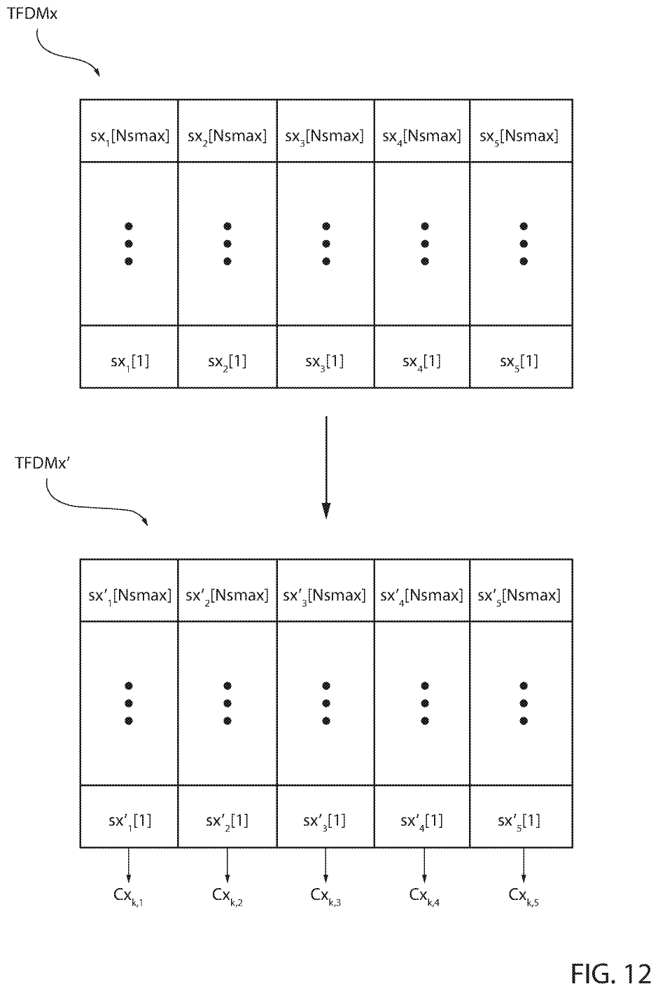

Consequently, for each unknown flight segment, the computer 19 acquires a corresponding matrix of unknown data TFDMx, whose columns are formed by the series of unknown samples sx₁ [n]-Sx_{NQ} [n], as shown qualitatively in FIG. 12.

Subsequently, for each of the aforementioned unknown flight segments, the computer 19 performs (block 204, FIG. 11) a smoothing operation of each of the series of unknown samples sxᵢ [n] of the corresponding matrix of unknown data TFDMx, in the same manner as described with reference to block 106.

In more detail, it is assumed that the computer 19 still performs a “kernel nearest neighbour smoothing”; moreover, for each series of unknown samples sxᵢ [n] a corresponding unknown smoothed series sx′ᵢ [n] and a corresponding unknown approximating function Fxᵢ (t), which is defined by a corresponding set of coefficients Cx_{k,i}, as well as by the kernels forming the base functions ox (t), are determined. In the following reference is made to the set of coefficients Cx_{k,i} as the set of unknown coefficients Cx_{k,i}.

At the end of the operations referred to in block 204, the computer 19 stores a corresponding matrix of smoothed unknown data TEDMx′, whose columns are formed by the smoothed unknown series sx′ᵢ [n]-sx′_{NQ} [n], as shown again in FIG. 12, in which the associations present between each smoothed unknown series sx′ᵢ [n] and the corresponding set of unknown coefficients Cx_{k,i} are also shown. In practice, the matrix of smoothed unknown data TFDMx′ and the corresponding set of unknown coefficients Cx_{k,i} represent an unknown observation.

Then, for each unknown flight segment, the computer 19 applies (block 206, FIG. 11) the classifier to the unknown observation, i.e., to the matrix of smoothed unknown data TFDMX′ and to the corresponding group of sets of unknown coefficients with Cx_{k,i}, so as to obtain a corresponding probability vector formed by a number of elements equal to the number of clusters, and thus equal to the number of flight regimes NUM_REG; each element of the probability vector is associated with a corresponding cluster, and thus also with the flight regime associated with the cluster, and is equal to the probability (as estimated by the classifier) that the unknown observation belongs to the cluster, and thus refers to the flight regime associated with that cluster. The application of the classifier to the unknown observation is also a function of the aforementioned base functions ox (t), and thus of the aforementioned kernels. In practice, each element of the probability vector is equal to the distance of the unknown observation from the corresponding centroid, this distance being calculated on the basis of the results of the corresponding embeddings and of the aforementioned norm ∥(·)∥ *.

Subsequently, the computer 19 identifies (block 208) the flight regime in which the helicopter 1 operated relative to the unknown flight segment to which the unknown observation refers, by selecting the flight regime associated with the cluster corresponding to the element of the probability vector having the maximum value.

The detections of the flight regimes can then be used reliably to estimate the state of fatigue and therefore the residual fatigue life of the components of an aircraft; consequently, such detections can be used, for example, to optimise the maintenance operations of a fleet of aircrafts, respecting the safety requirements.

The advantages that the present method allows to obtain emerge clearly from the previous description.

In particular, this method allows to detect with precision the flight regimes, without the need to resort to classifiers trained in a supervised manner and in a sensitive way to the temporal evolution of the primary quantities, overcoming the reduction in precision that can occur in the case of methods based on the extraction of features, as well as due to the discrepancy between the time-continuous nature of the temporal evolution of the primary quantities during the flights and the time-discrete nature of the corresponding series of samples.

In addition, thanks to the use of a fuzzy classifier, the occurrence of any mixed flight regimes (i.e. flight regimes other than those used during training) does not affect the correctness of the detection.

Clearly, changes may be made to the method and system described and shown herein without, however, departing from the scope of the present invention, as defined in the accompanying claims.

For example, smoothing may be of a different type than described. Furthermore, as previously mentioned, the operations of registration and generation of the processed sample series can be omitted.

The series of samples sᵢⱼ [n] can be formed by different numbers of respective samples and/or by samples acquired with different sampling frequencies, in which case the series of samples can be further processed in order to standardise their lengths.

In order to generate the data for training the classifier, flights of several aircrafts (preferably of the same type), equipped with respective monitoring systems adapted to acquire samples of the same quantities, may be used in addition to several flights of the same aircraft. Similarly, the unknown flight may be performed by an aircraft other than the aircraft(s) used to train the classifier.

Finally, it is possible to use a non-fuzzy classifier, however this entails the loss of the benefits connected with this feature, and in particular a reduction in the detection capacity in the presence of intermediate flight regimes compared to those adopted in the training step. In addition, in the case of the fuzzy classifier, it may be different from a C-means classifier; for example, the classifier may be formed by a DBSCAN or hierarchical type clusteriser.

1. Method implemented by computer (19) for detecting flight regimes of an aircraft (1) equipped with a monitoring system (2) configured to acquire samples of a number of quantities relating to the flight of the aircraft, comprising the steps of:
during a flight of the aircraft, acquiring (202) at least one unknown matrix (TFDMx) including, for each quantity, a corresponding series of samples (sx₁ [n]-Sx_{NQ} [n]);
performing (204) smoothing operations of each series of samples (sx₁ [n]-Sx_{NQ} [n]) of the unknown matrix (TFDMx), so as to generate a corresponding smoothed sample series (sx′₁[n]-SX′_{NQ} [n]) and so as to determine a corresponding approximating function (Fxᵢ (t)) defined by a respective set of coefficients (Cx_{k,i}) and by a plurality of base functions (φₖ (t)), the smoothed sample series forming an unknown smoothed matrix (TFDMx′);
on the basis of the base functions (φₖ (t)), applying (206) to the smoothed unknown matrix (TFDMx′) and to the corresponding sets of coefficients (Cx_{k,i}) a classifier trained to generate, for each flight regime among a plurality of flight regimes, a corresponding estimate of the probability that the unknown smoothed matrix (TFDMx′) and the corresponding sets of coefficients (Cx_{k,i}) belong to a cluster relative to said flight regime; and
identifying (208) a flight regime wherein the aircraft operated during said flight, based on the estimates generated by the classifier.

2. Method according to claim 1, wherein said corresponding approximating function (Fxᵢ (t)) is a function of time; and wherein said smoothing operations of each series of samples (sx₁ [n]-sx_{NQ} [n]) of the unknown matrix (TFDMx) is such that the corresponding smoothed sample series (sx′₁[n]-sx′_{NQ} [n]) is formed by values of the corresponding approximating function (Fxᵢ (t)).

3. Method according to claim 2, wherein said corresponding approximating function (Fxᵢ (t)) is of the time-continuous type.

4. Method according to claim 1, wherein said classifier has been generated by performing the steps of, for each flight regime of said plurality of flight regimes:
for each time interval of a plurality of time intervals in which said aircraft (1) or one or more aircrafts other than said aircraft and equipped with respective monitoring systems have operated in the flight regime, acquiring (102) corresponding training matrices (TFDM [j,m]), each of which includes, for each quantity, a corresponding series of training samples (sᵢⱼ [n]);
for each training matrix (TFDM [j,m]), performing (106) smoothing operations of each series of training samples (sᵢⱼ [n]) of the training matrix (TFDM [j,m]) so as to generate a corresponding smoothed series of training samples (s′ᵢⱼ [n]) and so as to determine a corresponding approximating function (Fᵢⱼ (t)) defined by a respective set of coefficients (C_{k,ij}) and by said plurality of base functions (φₖ(t)), the smoothed series of training samples (s′ᵢⱼ [n]) forming a smoothed training matrix (TFDM′ [j,m]);
for each smoothed training matrix (TFDM′ [j,m]), determining (108,110), for each smoothed series of training samples (s′ᵢⱼ [n]) of the smoothed training matrix (TFDM′[j,m]), a corresponding processed series of training samples (s″ᵢⱼ [n]), which is either equal to the smoothed series of training samples (s′ᵢⱼ [n]) or is equal to a temporal shift of the smoothed series of training samples (s′ᵢⱼ [n]), the processed series of training samples (s″ᵢⱼ [n]) forming a corresponding processed training matrix (TFDM″[j,m]);
and wherein the classifier has further been generated by performing the step of:
training (200) the classifier on the basis of observations including, each, a corresponding processed training matrix (TFDM″[j,m]) and the corresponding sets of coefficients (C_{k,ij}), so as to identify, for each flight regime of said plurality of flight regimes, the centroid of the corresponding cluster.

5. Method according to claim 4, wherein, for each training matrix (TFDM [j,m]), said smoothing operations of each series of training samples (sᵢⱼ [n]) of the training matrix (TFDM [j,m]) are such that the corresponding smoothed series of training samples (s′ᵢⱼ [n]) is formed by values of the corresponding approximating function (Fᵢⱼ (t)).

6. Method according to claim 4, wherein the classifier has further been generated by performing the step of:
for each quantity, performing (108) a shift registration procedure of the approximating functions (Fᵢⱼ (t)) relative to the smoothed series of training samples (s′ᵢⱼ [n]) relative to the quantity, so as to determine, for each of said approximating functions (Fᵢⱼ (t)), a corresponding shifted approximating function (F*ᵢⱼ (t)), which is temporally shifted with respect to the corresponding approximating function (Fᵢⱼ (t)) by a corresponding phase shift (Δᵢⱼ);
and wherein, in each processed training matrix (TFDM″[j,m]), each processed series of training samples (s″ᵢⱼ [n]) is obtained by shifting the corresponding smoothed series of training samples (s′ᵢⱼ [n]) by a time equal to the phase shift (Δᵢⱼ) present between the corresponding approximating function (Fᵢⱼ (t)) and the corresponding shifted approximating function (F*ᵢⱼ (t)).

7. Method according to claim 4, wherein said step of training (200) the classifier comprises determining, for each observation, respective degrees of membership to the clusters, said method comprising associating (201) to each cluster a corresponding flight regime among said plurality of flight regimes, as a function of the flight regimes to which the observations refer and of the degrees of membership to the clusters of the observations.

8. Method according to claim 1, wherein said smoothing operations comprise performing a kernel nearest neighbour smoothing.

9. Method according to claim 1, wherein the classifier is of the fuzzy type.

10. Method according to claim 9, wherein the classifier is a fuzzy C-means classifier.

11. Processing system comprising means configured to carry out the method according to claim 1.

12. Computer program comprising instructions which, when the program is executed by a computer (19), cause the execution of the method according to claim 1.

13. Computer medium readable by a computer (19), on which the computer program according to claim 12 is stored.
